(19) United States
(12) Patent Application Publication
(10) Pub. No.: US 2008/0126512 A1
(43) Pub. Date: May 29, 2008

(54) Remote control unit for changing allocated URL channel numbers.

(76) Inventor: Mehran Randall Rasti, (US)

Correspondence Address: MEHRAN RANDALL RASTI, 13040 SUGAR BOWL AVE., BATEN ROUGE, LA, 70814, US

(21) Appl. No.: 11/563,216

(22) Filed: Nov. 27, 2006

(51) Int. Cl. G06F 15/16

(52) U.S. Cl. 709/217

(57) ABSTRACT

The invention provides the means for allocating channel numbers to web site addresses (URLs) that offer movies and presentations through web-sites on the internet for viewers of such programs to be able to change program material by changing channels, just as they would on TV. A computer is embedded or connected to a video, projection, and/or large screen. A simple data-base is defined on the connected computer with a channel-number-key-field that relates channel-numbers to URLs of interest. The channel-number-key-field is pointed to a RAM address that receives a channel-number from a remote controller. Once a channel-number is selected, the data-base retrieves the URL of interest into a location in the computer memory that in turn shares a pointer address with the variable in browser software that is also running in the computer. The browser displays the selected web-site, once it receives the passed-on URL with an appended ASCII-13 character.

### CROSS REFERENCE TO RELATED APPLICATIONS

| U.S. Pat. No.: | Date: | Inventor: |
|---|---|---|
| 7,132,956 | Nov. 7, 2006 | Haruki, et al. |
| 7,136,872 | Nov. 14, 2006 | Mercer, et al. |
| 7,134,094 | Nov. 7, 2006 | Stabb, et al. |
| 7,130,841 | Oct. 31, 2006 | Goel, et al. |

### FEDERALLY SPONSORED RESEARCH OR DEVELOPMENT

Not Applicable

### REFERENCES TO SEQUENCE LISTING, TABLE, OR COMPUTER PROGRAM TABLES

None

### COMPUTER PROGRAMS

None

### BACKGROUND OF INVENTION

1. Field of Invention

Viewing television programs, web-casts, and presentations through the internet will soon become a common place. Integration of small computers with television and wide-screen projection and display systems will also become transparent to a degree that the combination will be viewed as one device. This integration coupled with the blurring line between television broadcasts and web casts will soon lead to the natural desire to be able to use a remote control unit to select and change web cast channels very much like TV channels. This invention defines such a system for doing just that. It defines the hardware and software components necessary so that a person can watch and select between internet web addresses and contents therein by pushing numbers on a remote control just like they would for TV channels, instead of having to do it on a computer keyboard.

2. Status of Prior Art

Currently the market is flooded with remote-control-units for changing television channels by channel-number. There are also a few brands of remote-control-units on the market that are specially designed to pause, play, stop, rewind, and fast-forward display coming out of a computer or a projector connected to a computer; however, none to change a preset channel number that is preset to a URL (Uniform Resource Locator) in order to select and retrieve the contents directly from a remote controller away from the computer-television-setup.

### SUMMARY OF INVENTION

A computer is hooked up to the internet and can retrieve web sites using browser software. The browser software retrieves the material for viewing through a web address called Uniform Resource Locator (URL).

The computer may or may not have a screen for display or it may be connected to a large screen or projection unit. A large display setup serves in cases where the web site display is to be viewed from distance and is useful for showing movies or computer presentations out of the internet.

By using software already available on the market, a computer user can create a two column table in the computer. In each row of such a table, the first column will hold a numerical value of 1 through 999, higher or lower, depending on the user's needs. These are going to serve as program-channel-numbers that our remote controller unit would be able to address. The second column on each row would contain a URL of a web page to be displayed on the screen by a web-page-browser-software when the channel number in the first column of that row is selected.

The two-column table of channel numbers and URLs, is named “Channel-Table”. This is constructed to be a “direct-access table” by defining the “channel-number-column” to be a unique-access-key. Any simple data base or direct-access-file-program can be used to create a data table as such, and to manage the access to it.

A small software modification is made to a web-browser software existing in public domain, such as Mozilla FireFox, enabling the browser's URL data-holder-variable to be referenced by a URL-value that is retrieved out of the Channel-Table upon a channel-number selection. Referencing may be accomplished by value or through pointer addressing.

The selected URL contents is thus displayed on the computer and/ or big screen.

### DESCRIPTION OF THE DRAWINGS

FIG. 1: Schematic diagram showing remote control selection of pre-set URLs by channel numbers.

This diagram shows the way a specially designed remote control unit is interfaced and communicates with a computer-video-unit in changing a channel number that is pre-set to a web-site-URL.

### DETAILED DESCRIPTION

The invention consists of a remote control unit that is capable of changing programs that are presented over the internet on a computer display that may be a component of a large screen television display or a projection TV system. This is done by allocating a channel number to a web site URL (Uniform Resource Locator) of interest. Such web sites may present movies and programming similar to the ones available on television station channels. Having such a remote control available, a user can allocate channel numbers to different URLs of interest and to change and select viewing them by using the said remote controller, without having to go to a computer keyboard and typing in a different URL every time.

With reference to FIG. 1, the following describes the way the remote control unit works:
1. Computer 1 is capable to access many URLs of interest on the internet through path 2. This computer must have access to the internet and run a browser software.
2. Computer 1 has a display unit, and/ or is also connected to a display system, a digital projection, or a television system 4 through path 3.
3. Remote controller 5 sends in a signal designating a channel number to the remote-controller-unit 6 via infra-red or a short wave frequency that is allocated (by FCC) to be used for sort range small device communication.
4. Remote-controller-unit 6 accepts the electronic signal when sent by remote controller device 5, changes it to a binary value that represents the channel number selected, and sends it to computer 1.
5. Computer 1 receives the binary value representing the selected channel number from the remote-controller-unit 6 through path 7, and stores it with an appended ASCII-13 character in a program register (see FIG. 2) whose binary address is shared with a variable that represents the Channel-Table-Key variable. In programmers' language, the address of the memory location holding the selected channel-number is set to be the pointer to the variable defining the access key for the Channel-Table.
6. Computer 1 runs a small data base containing a two-column table, named “Channel-Table” consisting of channel numbers and URLs. Column 1 of this table that contains unique channel numbers is designated as the record-search-key. Column 2 of the same table contains URL values that a user has designated to be his/ her favorite web sites to retrieve and watch often. Therefore, each row of the table contains a channel number as an access-key that corresponds to a URL, and causes the retrieval of a user's favorite web site URL to be accessed.
7. Computer 1 also runs a browser software that can access web sites on the internet represented by the selected URL. The browser software receives selected URLs that are passed to it from what is retrieved from the table of channels through sharing the same memory address that is also defined for the variable that receives retrieved URL values from the Channel-Table (see FIG. 2). In programmers' terminology, the pointer to the browser URL selection variable has the same value as the pointer that points to the variable that holds the retrieved URLs from the Channel-Table.

Steps 1 through 7, above show how a user would control the selection of a URL of interest by pushing channel numbers on the specially designed remote control system that is dedicated to the selection and viewing of favorite web sites on a computer-television-display-system.

I claim

1. A computer remote control device for changing viewable channels that are pre-assigned to internet web site URLs (Uniform Resource Locators), when contents are retrieved by computer circuits and is delivered to a video, projector, or a computer-television-device via wired or wireless means.

2. The computer-television-device in claim 1 in which a two column data table lists arbitrary channel numbers as unique access keys in the table's first column, and relates those with the corresponding URL data located in the second column of the same row, such that accessing a channel number in the first column will result in the retrieval of the URL data located in the second column of the same row.

3. The computer-television-device in claim 1 in which an internet-browser-like software is capable of receiving the selected URL information from the data table in claim 2 and to push the retrieved web page data corresponding to the said URL into the computer-device-output-buffer for display on a self contained or external video display, projection unit, and/ or television.

4. The computer-television-device claim 1 in which dedicated circuits communicate with the remote control in claim 1 through a remote-control-controller-unit that is located inside or outside the perimeter of the computer-television-combination device in claim 1.

5. The computer remote control unit in claim 1 comprising a remote numeric keypad or keyboard that communicates to a computer and/or computer-television-combination device in claim 1 through a remote-control-controller-unit in claim 4 to set and change television channel numbers in claim 2, as well as other functions found on most other video-remote-control-units.

6. The remote control in claim 1 communicates with its remote-control-controller-unit in claim 4 via infra-red, short-wave and other digital frequencies that are allocated to short-distance communication between small electronic devices including WIFI, and the like.
